(19) United States
(12) Patent Application Publication
(10) Pub. No.: US 2021/0065204 A1
(43) Pub. Date: Mar. 4, 2021

(54) ANALYZING METHOD, ANALYZING DEVICE, AND COMPUTER-READABLE RECORDING MEDIUM

(71) Applicant: FUJITSU LIMITED, Kawasaki-shi (JP)

(72) Inventors: Yuki Ishiguro, Odawara (JP); Hinata Kishi, Yokohama (JP); Naofumi Iwasa, Yokohama (JP); Shouta Watanabe, Zushi (JP)

(73) Assignee: FUJITSU LIMITED, Kawasaki-shi (JP)

(21) Appl. No.: 17/096,021

(22) Filed: Nov. 12, 2020

Related U.S. Application Data
(63) Continuation of application No. PCT/JP2018/018618, filed on May 14, 2018.

(51) Int. Cl. G06Q 30/00; H04L 12/58; G06Q 10/10; G06Q 10/06; G06F 16/26

(52) U.S. Cl. CPC G06Q 30/016; H04L 51/02; G06F 16/26; G06Q 10/06398; G06Q 10/10

(57) ABSTRACT

A non-transitory computer-readable recording medium stores therein an analyzing program that causes a computer to execute a process including referring to a storage, upon receipt of an instruction to display content of inquiries received and gathered from a plurality of terminals, the storage storing therein the content of the inquiries analyzed based on a plurality of indices including indices related to a human service and a chatbot service offered in response to the inquiries, and displaying an at-a-glance view of a plurality of analysis results obtained by analyzing the content of the inquiries based on the plurality of indices, and displaying, upon receipt of a designation for an analysis on the human service among the plurality of analysis results displayed, a breakdown of the indices related to the human service and the chatbot service, in addition to statistical information about the human service for each specific unit time period.

### CROSS-REFERENCE TO RELATED APPLICATION

This application is a continuation application of International Application No. PCT/JP2018/018618, filed on May 14, 2018 and designating the U.S., the entire contents of which are incorporated herein by reference.

### FIELD

The present invention relates to an analyzing method, an analyzing device, and a computer-readable recording medium.

### BACKGROUND

In recent years, FAQ systems used by corporations to offer customer services include systems using a chatbot together with human chats offered by operators. By using such a chatbot, it is possible to offer customer service even outside business hours of human services, which makes it possible to gather the voice of more customers. Further, at corporations, by analyzing information gathered from the customer service offered by such a FAQ system, it is possible to improve problems by making service issues and customers' interest more evident.

As a related technique for analyzing gathered information, an analysis data managing device is known which makes it possible to efficiently check a large number of analysis results obtained from batch processing or the like, by displaying at-a-glance view of a chromatogram and a spectrum waveform image indicating a plurality of analysis results.

Patent Document 1: Japanese Laid-open Patent Publication No. 2006-153628

Patent Document 2: Japanese Laid-open Patent Publication No. 2010-165292

Patent Document 3: Japanese Laid-open Patent Publication No. 2012-238149

### SUMMARY

According to an aspect of the embodiments, a non-transitory computer-readable recording medium stores therein an analyzing program that causes a computer to execute a process including: referring to a storage, upon receipt of an instruction to display content of inquiries received and gathered from a plurality of terminals, the storage storing therein the content of the inquiries analyzed based on a plurality of indices including indices related to a human service and a chatbot service offered in response to the inquiries, and displaying an at-a-glance view of a plurality of analysis results obtained by analyzing the content of the inquiries based on the plurality of indices; and displaying, upon receipt of a designation for an analysis on the human service among the plurality of analysis results displayed in the at-a-glance view, a breakdown of the indices related to the human service and the chatbot service, in addition to statistical information about the human service for each specific unit time period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary configuration of a FAQ system;

FIG. 2 is an explanatory drawing illustrating an example of a chat screen;

FIG. 3 is a block diagram illustrating an exemplary functional configuration of an analyzing device according to an embodiment;

FIG. 4 is a flowchart illustrating an example of operations of the analyzing device according to the embodiment;

FIG. 5 is an explanatory drawing illustrating an example of a dashboard screen;

FIG. 6A is an explanatory drawing illustrating an example of an action count area;

FIG. 6B is an explanatory drawing illustrating an example of a room count area;

FIG. 6C is an explanatory drawing illustrating an example of a day-type-based user action count area.

FIG. 6D is an explanatory drawing illustrating an example of a time-slot-based action count area;

FIG. 6E is an explanatory drawing illustrating an example of a benefit level area;

FIG. 6F is an explanatory drawing illustrating an example of an interested field area;

FIG. 7 is an explanatory drawing illustrating an example of displaying breakdowns of analyses on human services;

FIG. 8 is an explanatory drawing illustrating another example of displaying breakdowns of the analyses on the human services;

FIG. 9A is an explanatory drawing for explaining a narrow-down process using a criterion;

FIG. 9B is another explanatory drawing for explaining the narrow-down using a criterion; and

FIG. 10 is a block diagram illustrating an exemplary hardware configuration of the analyzing device according to an embodiment.

### DESCRIPTION OF EMBODIMENTS

The abovementioned related technique, however, has a problem where it is difficult to perform an analysis while separating human services from chatbot services, out of the information gathered from the FAQ system. For this reason, for example, it is difficult to proceed with a verification while separating processing time of the chatbot services from processing time of the human services. It is therefore difficult to find the situations where, for example, a human service takes shorter processing time than a chatbot service does.

In one aspect, it is an object to provide an analyzing program, an analyzing method, and an analyzing device capable of easily performing an analysis while separating human services from chatbot services.

Preferred embodiments will be explained with reference to accompanying drawings. Some of the constituent elements of the embodiments that have mutually the same functions will be referred to by using the same reference characters, and duplicate explanations will be omitted. The analyzing programs, the analyzing methods, and the analyzing devices described in the following embodiments are merely examples and are not intended to limit the embodiments. Further, any of the embodiments described below may be combined as appropriate as long as no conflict occurs.

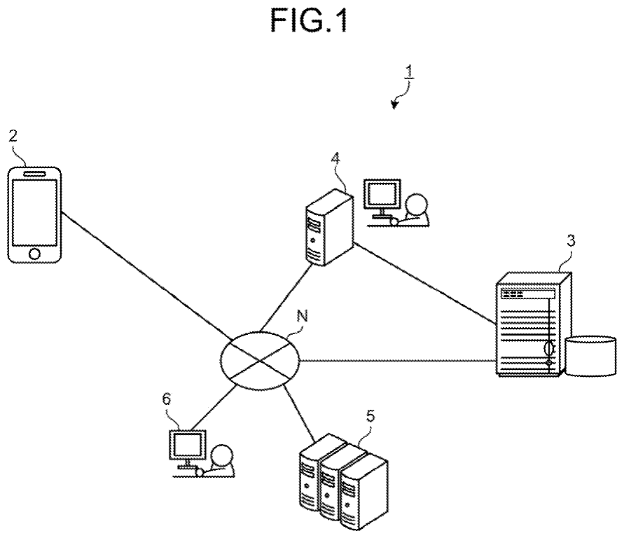

FIG. 1 is a block diagram illustrating an exemplary configuration of a FAQ system. As illustrated in FIG. 1, an FAQ system 1 is a system that, in a chat format, responds to inquiries received from a plurality of terminals 2 of customers, via a communication network N such as the Internet.

As the communication network N, it is possible to use any of arbitrary types of communication networks such as the Internet, a Local Area Network (LAN), or a Virtual Private Network (VPN), in a wired or wireless manner.

Services offered by the FAQ system 1 in the chat format include human chats offered by operators and automated chats offered by a chatbot using an automatic conversation program. In the present embodiment, an example will be explained in which both the human chats and the automated chats use the format where chats are carried out with text inputs and inputs of selecting operations. Alternatively, the inquiries and the responses may be made through audio.

Each of the terminals 2 is a terminal device owned by a customer using the FAQ system 1 and may be, for example, a smartphone, a tablet terminal, or a Personal Computer (PC). Each of the terminals 2 is configured to access a chat provided by the FAQ system 1, by using a browser or a dedicated application program.

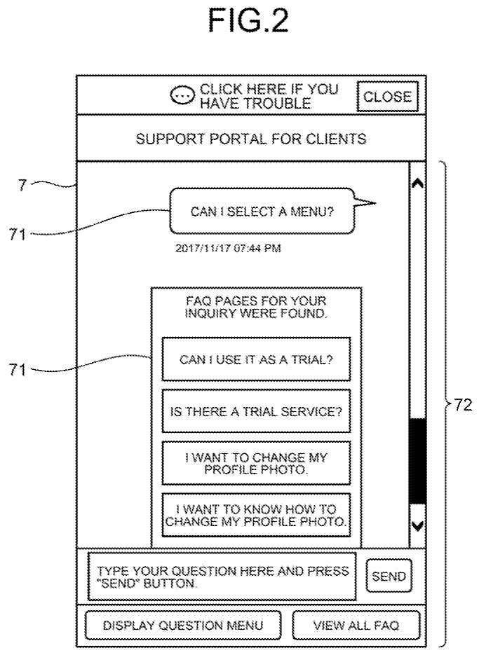

FIG. 2 is an explanatory drawing illustrating an example of a chat screen. As illustrated in FIG. 2, a chat screen 7 is a display screen on which actions 71 related to the inquiries and the responses are carried out in the chat format. Each of the terminals 2 is configured to display the chat screen 7 by accessing the FAQ system 1.

The actions 71 are utterances of the user of a terminal 2 and a responder (i.e., an operator in a human chat or the chatbot in an automated chat). The actions 71 include selections made with click operations and text inputs and are displayed by using a balloon format, for example. The series of actions 71 carried out by accessing the FAQ system 1 are managed as a conversation (called a “room”) 72. In other words, the conversation (room) 72 is put together while regarding the start to the end of the chat as a unit.

Triggered by the access from the terminal 2, the FAQ system 1 starts up the conversation (room) 72 to which unique identification information (e.g., a room ID) is assigned. Further, the FAQ system 1 manages a history of the actions 71 in the conversation (room) 72 so as to be kept in association with the identification information of the conversation (room) 72, as a log of the conversation (room) 72. Information managed as the log of the conversation (room) 72 includes, for example, the content of selections and inputs related to the inquiries and the responses.

Further, the information managed as the log also includes information at the times of starting the chat and ending the chat of the conversation (room) 72. More specifically, the information at the time of starting the chat may be information about the entrance (the inflow origin) through which an entry was made to the chat service of the FAQ system 1. For example, the information about the inflow origin may be information indicating a link origin used when the access was made from the terminal 2 via a link on a homepage or a Social Networking Service (SNS) or information indicating the terminal 2 represented by a PC or a mobile device.

Further, the information at the time of ending the chat may be information indicating a redirection destination to which a redirection was made as a response or information indicating an ending state of the chat. The information indicating the redirection destination may indicate a redirection from an automated chat to a human chat or a redirection to an external system (e.g., a homepage). Further, the information indicating the ending state of the chat may indicate a disconnection of the access by the terminal 2, a termination made by the redirection to a redirection destination, a normal termination, or the like.

Returning to the description of FIG. 1, the FAQ system 1 includes a host computer 3, a monitoring device 4, an analyzing device 5, and an analyzing terminal 6, which are connected together by the communication network N or the like so as to be able to communicate with one another.

The host computer 3 is a server device configured to provide the chat service of the FAQ system 1. In response to the access from the terminal 2, the host computer 3 starts up the conversation (room) 72 to which the unique identification information (e.g., the room ID) is assigned and starts the chat service by the chatbot. Further, upon starting the chat service, the host computer 3 records a log of the automated chat of the conversation (room) 72. Further, when being instructed to connect to a human chat in an action 71 from the terminal 2, the host computer 3 instructs the monitoring device 4 to start the human chat in the conversation (room) 72, with the identification information of the conversation (room) 72 being provided.

The monitoring device 4 is a terminal device of an operator who is in charge of the human chat. When being instructed by the host computer 3 to start the human chat, with the identification information of the conversation (room) 72 being provided, the monitoring device 4 is configured to carry out the human chat in the conversation (room) 72, by presenting the operator with a screen similar to or the same as the chat screen 7. Further, upon starting the human chat, the monitoring device 4 is configured to record a log of the human chat in the conversation (room) 72.

With this configuration, the FAQ system 1 is able to offer a service of the human chat by the monitoring device 4, continued from the automated chat by the chatbot of the host computer 3. Further, the logs of the automated chat and the human chat in the conversation (room) 72 are managed by the host computer 3 and the monitoring device 4, while being kept in association with the identification information of the conversation (room) 72.

The analyzing device 5 is an information processing device configured to gather the logs managed by the host computer 3 and the monitoring device 4 and to analyze the content of the inquiries received and gathered from the plurality of terminals 2 based on various indices set in advance. For instance, examples of the indices to be analyzed include inflow origins and redirection destinations of the chats, a detailed breakdown of the actions 71, and processing time of the automated chats and the human chats.

The analyzing terminal 6 is a terminal device used by an analyzer (a user) who analyzes information gathered in customer services of the FAQ system. The analyzing terminal 6 is configured to send an instruction related to an analysis received from the user to the analyzing device 5, to receive display data of analysis results from the analyzing device 5, and to display the received data. Accordingly, the user is able to analyze the information gathered in the customer services of the FAQ system 1.

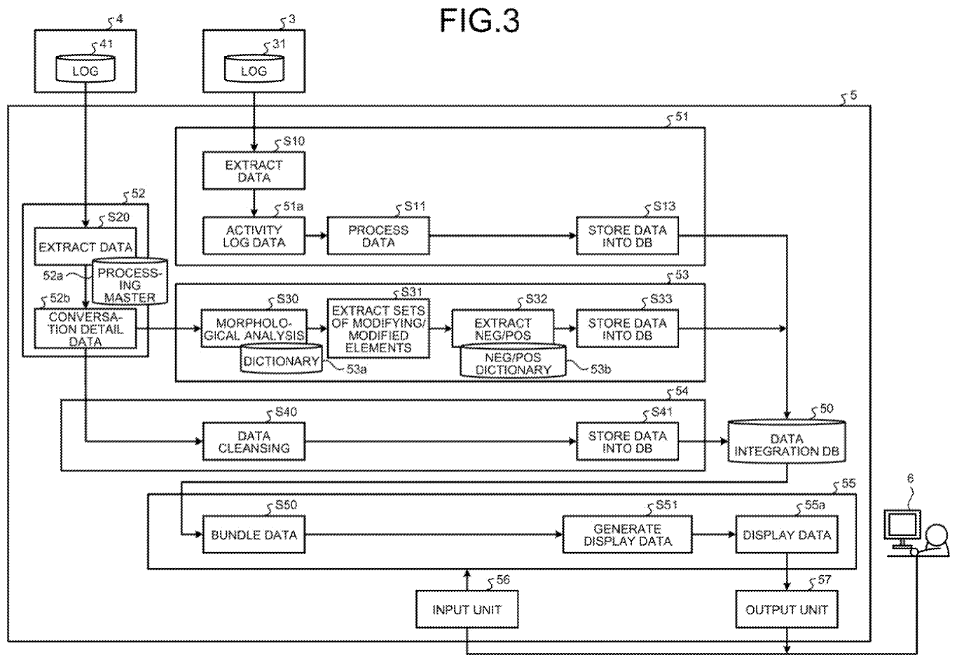

FIG. 3 is a block diagram illustrating an exemplary functional configuration of the analyzing device 5 according to the embodiment. As illustrated in FIG. 3, the analyzing device 5 includes: a data integration DB 50, a bot data analyzing unit 51, a conversation extracting unit 52, a conversation analyzing unit 53, a cleansing unit 54, a display processing unit 55, an input unit 56, and an output unit 57.

The data integration DB 50 is a database configured to manage the analysis results obtained by analyzing conversations (rooms) 72, by gathering logs 31 and 41 of the host computer 3 and the monitoring device 4 and having the gathered logs 31 and 41 routed through the bot data analyzing unit 51, the conversation extracting unit 52, the conversation analyzing unit 53, and the cleansing unit 54. More specifically, the data integration DB 50 has stored therein the content of the inquiries in the conversations (rooms) 72 analyzed based on the plurality of indices set in advance including indices related to the human services and the chatbot services offered in response to the inquiries. In other words, the data integration DB 50 is an example of the storage unit.

The indices to be analyzed are set by the user as appropriate and may include, for example, chat dates and times, inflow origins and redirection destinations of the chats, detailed breakdowns of the actions 71, and processing time of the automated chats and the human chats. Further, for the content of the conversations in the conversations (rooms) 72, the indices may include: the number of responses using a predetermined selectable option (e.g., Yes/No), how many times a predetermined keyword appeared in the content of the conversations, and modifying/modified elements analyses and neg/pos analyses using keywords.

Based on the predetermined indices, the bot data analyzing unit 51 analyzes the content of the actions 71 (the bot data) related to the automated chats in the conversations (rooms) 72 from the log 31 in the host computer 3 and stores analysis results into the data integration DB 50. More specifically, by referring to the identification information (e.g., the room IDs), the bot data analyzing unit 51 extracts data from the log 31 with respect to each of the conversations (rooms) 72 (step S10).

Subsequently, on extracted activity log data 51a, the bot data analyzing unit 51 performs data processing such as arranging the data in a chronological order and subsequently performs an analysis with respect to each of the indices such as the chat dates and times, the inflow origins and redirection destinations of the chats, and the processing time from the start to the end (step S11). In this situation, with respect to the activity log data 51a arranged in the chronological order, the bot data analyzing unit 51 may analyze along what scenarios (lines of flow) the dialogs in the automated chats are developed, by comparing the data with talk scripts of chatbots. After that, the bot data analyzing unit 51 stores analysis results into the data integration DB 50, together with the identification information of the conversations (rooms) 72 (step S13).

The conversation extracting unit 52 extracts the content of the conversations related to the human chats in the conversations (rooms) 72 from the log 41 in the monitoring device 4. More specifically, by referring to the identification information (e.g., the room IDs), the conversation extracting unit 52 extracts data from the log 41, with respect to each of the conversations (rooms) 72. Subsequently, by referring to a processing master 52a determined in advance for the purpose of extracting conversation sections, the conversation extracting unit 52 extracts conversation detail data 52b indicating details of the conversations (e.g., the content of the conversations being input by using text) in the human chats in the conversations (rooms) 72 (step S20).

Based on the conversation detail data 52b extracted with respect to the conversations (rooms) 72, the conversation analyzing unit 53 analyzes the content of the conversations in the human chats based on the predetermined indices and stores analysis results into the data integration DB 50.

More specifically, by referring to a dictionary 53a related to natural language processing, the conversation analyzing unit 53 performs a morphological analysis on the conversation detail data 52b (step S30) and extracts predetermined keywords appearing in the content of the conversations. Further, based on the extracted keywords, the conversation analyzing unit 53 extracts sets that are each made up of modifying and modified elements by combining predetermined keywords (step S31). More specifically, the conversation analyzing unit 53 extracts sets of keywords such as “expensive”/“inexpensive” corresponding to “price”.

Further, based on the extracted sets of modifying/modified elements, the conversation analyzing unit 53 extracts information indicating whether the content of the conversations is negative (neg) or positive (pos) (step S32). More specifically, based on the sets of keywords and a neg/pos dictionary 53b indicating neg/pos evaluations of various sets, the conversation analyzing unit 53 evaluates the content of the conversations as being negative or positive. For example, with respect to the content of a conversation stating that “the price is expensive”, the conversation analyzing unit 53 evaluates that the content of the conversation is negative based on the set made up of “price” and “expensive”. Conversely, with respect to the content of a conversation stating that “the price is inexpensive”, the conversation analyzing unit 53 evaluates that the content of the conversation is positive based on the set made up of “price” and “inexpensive”.

Subsequently, the conversation analyzing unit 53 stores the extracted keywords, the sets made up of the modifying/modified elements, and the neg/pos evaluations into the data integration DB 50 as analysis results, together with the identification information of the conversations (rooms) 72 (step S33).

Based on the conversation detail data 52b extracted with respect to the conversations (rooms) 72, the cleansing unit 54 performs analyses based on indexes such as the processing time of the conversations in the human chats and how many Yes's and No's were selected and stores analysis results into the data integration DB 50. More specifically, the cleansing unit 54 performs a data cleansing process on the conversation detail data 52b (step S40) and extracts information such as the processing time from the start to the end of each conversation, how many times a predetermined selectable option was selected, the click counts, and/or the like. After that, the cleansing unit 54 stores the extracted information into the data integration DB 50 as analysis results, together with the identification information of the conversations (rooms) 72 (step S41).

Based on a user instruction received from the analyzing terminal 6 via the input unit 56, the display processing unit 55 gathers data from the data integration DB 50 (step S50) and generates display data 55a displaying analysis results of the content of the inquiries received and gathered from the terminals 2 (step S51). Subsequently, by outputting the generated display data 55a to the analyzing terminal 6 via the output unit 57, the display processing unit 55 displays the analysis results corresponding to the user instruction, on the analyzing terminal 6.

More specifically, upon receipt of an instruction to display a dashboard screen displaying an at-a-glance view of the analysis results of the content of the inquiries received and gathered from the terminals 2, the display processing unit 55 gathers the analysis results obtained by analyzing the conversations (rooms) 72, based on the plurality of indices, by referring to the data integration DB 50. After that, based on the gathered analysis results, the display processing unit 55 obtains aggregated values that are aggregated by using predetermined criteria such as monthly, day-type-based, time-slot-based, and/or the like. Subsequently, based on the obtained aggregated values, the display processing unit 55 generates the display data 55a in which either the aggregated values themselves or graphs (e.g., a pie graph, a bar graph, a line graph, and/or the like) corresponding to the aggregated values are arranged according to a display format of the dashboard screen.

As a result of the generated display data 55a being output to the analyzing terminal 6, the analyzing terminal 6 displays the dashboard screen displaying an at-a-glance view of the analysis results. By referring to the dashboard screen displayed on the analyzing terminal 6, the user is able to easily perform an overall analysis on the customer services of the FAQ system 1.

Further, upon receipt of a designation for an analysis on the human services offered by the human chats, the display processing unit 55 further bundles together data involving a relay (a handover) from an automated chat to a human chat, from the analysis results gathered by referring to the data integration DB 50. More specifically, the display processing unit 55 bundles together the data including analysis results obtained by the conversation analyzing unit 53 and the cleansing unit 54, from among the analysis results of the conversations (rooms) 72.

Subsequently, by obtaining the aggregated values that are aggregated by using predetermined criteria based on the bundled analysis results, the display processing unit 55 obtains statistical information about the human chats in specific temporal units and breakdowns of the indices related to the human chats and the chatbot. After that, based on the obtained statistical information and index breakdowns, the display processing unit 55 generates display data 55a in which either the statistical information and index breakdowns themselves or corresponding graphs (e.g., a pie graph, a bar graph, a line graph, and/or the like) are arranged according to the display format of the dashboard screen.

As a result of the generated display data 55a being output to the analyzing terminal 6, the analyzing terminal 6 displays the dashboard screen displaying an at-a-glance view of the statistical information about the human chats in the specific temporal units and the index breakdowns related to the human chats and the chatbot. By referring to the dashboard screen displayed on the analyzing terminal 6, the user is able to easily perform analyses by separating the services offered by the human chats, from the services offered by the automated chats.

The input unit 56 is configured to receive the user instruction from the analyzing terminal 6 through communication via the communication network N and to output the received instruction to the display processing unit 55. The output unit 57 is configured to transmit the display data 55a generated by the display processing unit 55 to the analyzing terminal 6 through communication via the communication network N.

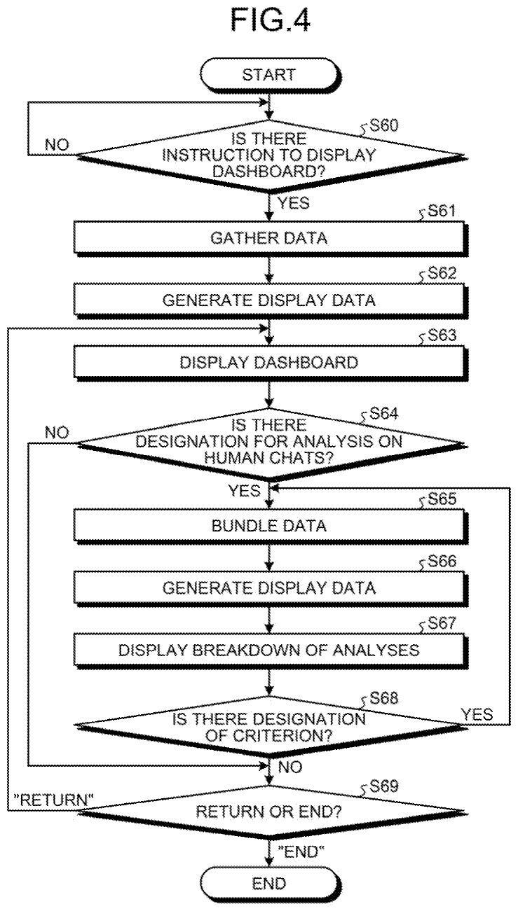

FIG. 4 is a flowchart illustrating an example of operations of the analyzing device according to the embodiment. As illustrated in FIG. 4, when a process is started, the display processing unit 55 judges whether or not there is an instruction to display the dashboard screen, based on instructions from the analyzing terminal 6 (step S60) and stands by for the process when there is no display instruction (step S60: No).

On the contrary, when there is a display instruction (step S60: Yes), the display processing unit 55 refers to the data integration DB 50 and gathers the data obtained by analyzing the conversations (rooms) 72 based on the plurality of indices (step S61).

Subsequently, based on the gathered data, the display processing unit 55 obtains aggregated values that are aggregated by using the predetermined criteria such as monthly, day-type-based, time-slot-based, and/or the like and generates the display data 55a for the dashboard screen displaying the graphs corresponding to the aggregated values, or the like (step S62). After that, the display processing unit 55 outputs the display data 55a to the analyzing terminal 6 via the output unit 57, so that the analyzing terminal 6 displays the dashboard screen based on the display data 55a (step S63).

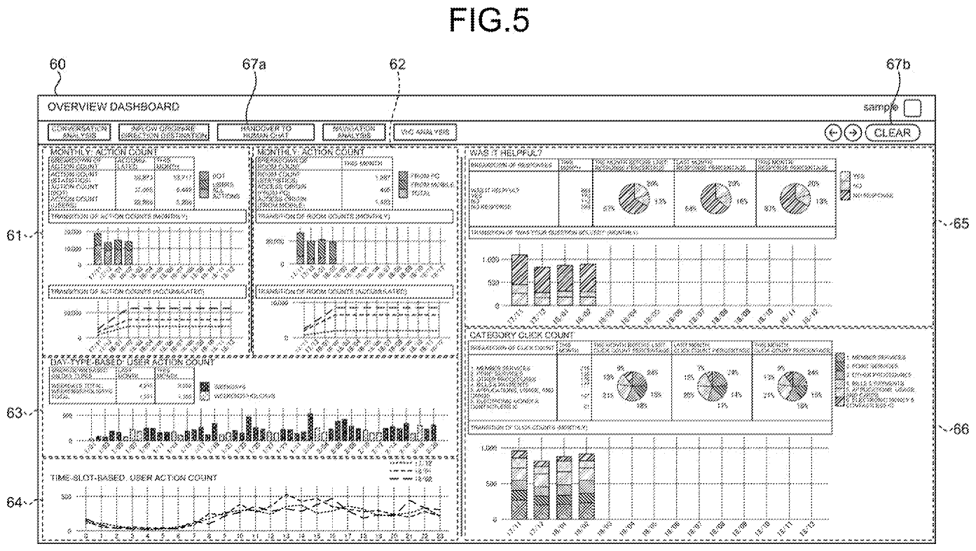

FIG. 5 is an explanatory drawing illustrating an example of the dashboard screen. As illustrated in FIG. 5, a dashboard screen 60 includes: an action count area 61, a room count area 62, a day-type-based user action count area 63, a time-slot-based action count area 64, a benefit level area 65, an interested field area 66, and buttons 67a and 67b. In these areas, the dashboard screen 60 displays the at-a-glance view of the analysis results of the content of the inquiries received and gathered from the terminals 2. Further, the dashboard screen 60 is configured to receive a designation for an analysis on the human services offered by the human chats, through an operation on the button 67a. Further, the dashboard screen 60 is configured to receive a cancellation of narrowed-down display using a predetermined criterion, through an operation on the button 67b.

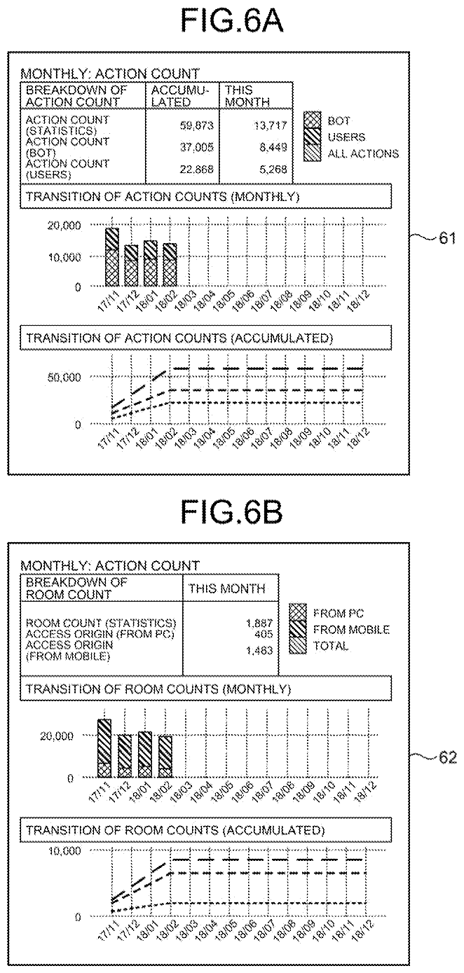

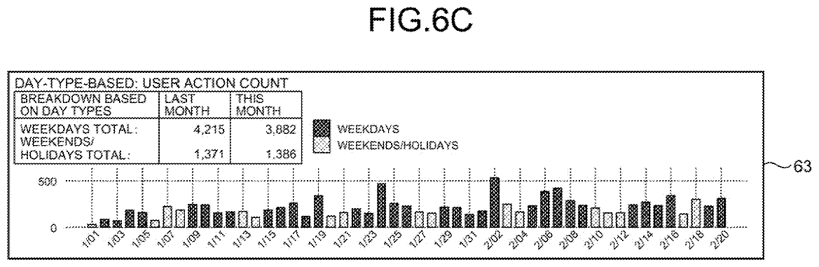

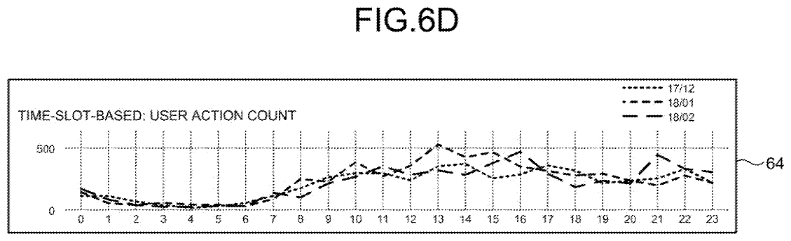

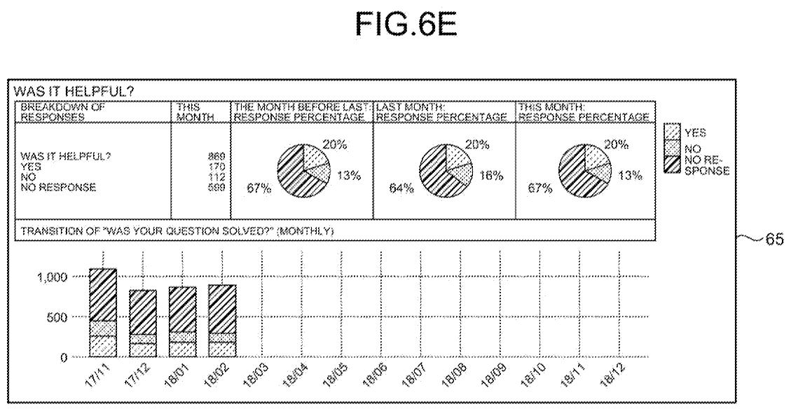

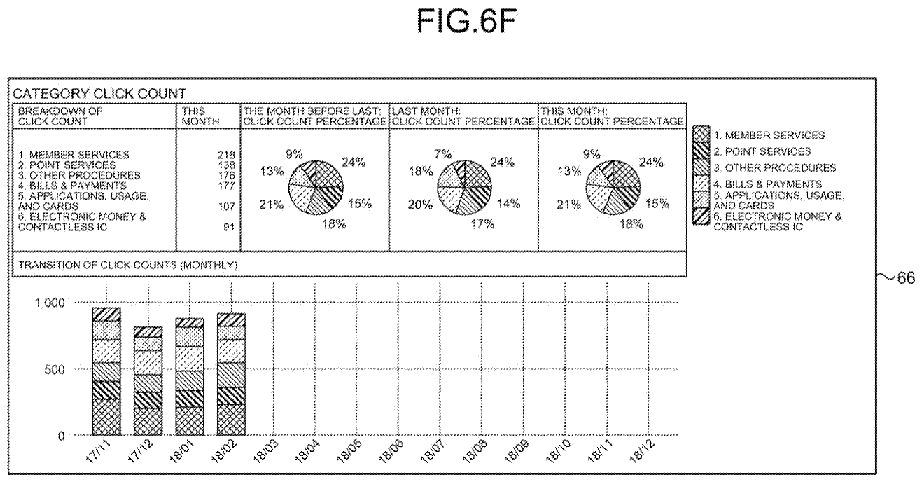

FIG. 6A is an explanatory drawing illustrating an example of the action count area 61. As illustrated in FIG. 6A, the action count area 61 is an area displaying the number of actions 71 aggregated for each month. More specifically, the action count area 61 displays aggregated values or graphs corresponding to the aggregated values based on indices such as a breakdown, transitions, and accumulated values of the monthly action counts. By referring to the action count area 61, the user is able to view the breakdown, the transitions, and the accumulated values of the monthly action counts. In the present example, “Total” or “All Actions” denotes a total value of the action counts from the human and automated chats. “Bot” denotes a total value of the action counts from the automated chats. “User” denotes a total value of the action counts from the human chats.

FIG. 6B is an explanatory drawing illustrating an example of the room count area 62. As illustrated in FIG. 6B, the room count area 62 is an area displaying the number of conversations (rooms) 72 aggregated for each month. More specifically, the room count area 62 displays aggregated values or graphs corresponding to the aggregated values based on indices such as a breakdown, transitions, and accumulated values of the monthly room counts. By referring to the room count area 62, the user is able to view the breakdown, the transitions, and the accumulated values of the monthly room counts. In the present example, “Total” denotes a total count of the rooms started up from all the terminals 2. “From PC” denotes a total count of the rooms started up from terminals 2 of which the inflow origin is a PC. “From Mobile” denotes a total count of rooms started up from terminals 2 of which the inflow origin is a mobile terminal such as a smartphone.

FIG. 6C is an explanatory drawing illustrating an example of the day-type-based user action count area 63. As illustrated in FIG. 6C, the day-type-based user action count area 63 is an area displaying the number of user actions (the number of utterances) for each of the day types. By referring to the day-type-based user action count area 63, the user is able to understand transitions in the number of utterances for each of the day types (e.g., weekdays and weekends/holidays).

FIG. 6D is an explanatory drawing for explaining an example of the time-slot-based action count area 64. As illustrated in FIG. 6D, the time-slot-based action count area 64 is an area displaying the number of user actions (the number of utterances) based on the time slots. By referring to the time-slot-based action count area 64, the user is able to understand transitions in the number of utterances based on the time of the day (daytime, nighttime, etc.).

FIG. 6E is an explanatory drawing illustrating an example of the benefit level area 65. As illustrated in FIG. 6E, the benefit level area 65 is an area indicating indices of degrees of benefits evaluated by the customers. More specifically, the benefit level area 65 displays aggregated values or graphs corresponding to the aggregated values regarding the number of displayed incidents asking for a response with a level of satisfaction to the question such as “Was your question solved?” and the number of responses regarding the level of satisfaction (the numbers of “Yes's”/“No's”) in the actions 71. By referring to the benefit level area 65, the user is able to view the degrees of benefits for the customers with regard to the services offered by the FAQ system 1.

FIG. 6F is an explanatory drawing illustrating an example of the interested field area 66. As illustrated in FIG. 6F, the interested field area 66 is an area indicating indices of interested fields evaluated by the customers. More specifically, the interested field area 66 displays aggregated values or graphs corresponding to the aggregated values regarding the number of clicks being clicked on categories of interest in the actions 71. By referring to the interested field area 66, the user is able to view the fields in which the customers are interested.

Returning to the description of FIG. 4, based on whether or not an operation was performed on the button 67a on the dashboard screen 60, the display processing unit 55 judges whether or not there has been a designation for an analysis on the human services offered by the human chats (step S64). When there has been no designation for the analysis (step S64: No), the display processing unit 55 judges at step S69 whether the process is to return to the dashboard screen 60 on which the narrow-down display is cancelled or the process is to be ended, based on a user instruction received from the analyzing terminal 6 via the input unit 56 (step S69). More specifically, when an operation is performed on the button 67b, it is deemed that cancellation of the narrow-down display is instructed, and the display processing unit 55 returns the process to Step S63. In contrast, when it is instructed to terminate the dashboard screen 60 or the like, the display processing unit 55 ends the process.

On the contrary, when there has been a designation for the analysis (step S64: Yes), the display processing unit 55 further bundles together data involving a relay (a handover) from an automated chat to a human chat, from the analysis results gathered by referring to the data integration DB 50 (step S65).

Subsequently, by obtaining aggregated values that are aggregated under predetermined criteria based on the bundled analysis results, the display processing unit 55 obtains statistical information about the human chats in specific temporal units and a breakdown of the indices related to the human chats and the chatbot. After that, the display processing unit 55 generates display data 55a displaying the obtained statistical information and index breakdowns on the dashboard screen 60 (step S66). Subsequently, the display processing unit 55 outputs the display data 55a to the analyzing terminal 6 via the output unit 57. The analyzing terminal 6 displays the dashboard screen indicating the breakdowns of the analyses on the human services, by displaying the display data 55a (step S67).

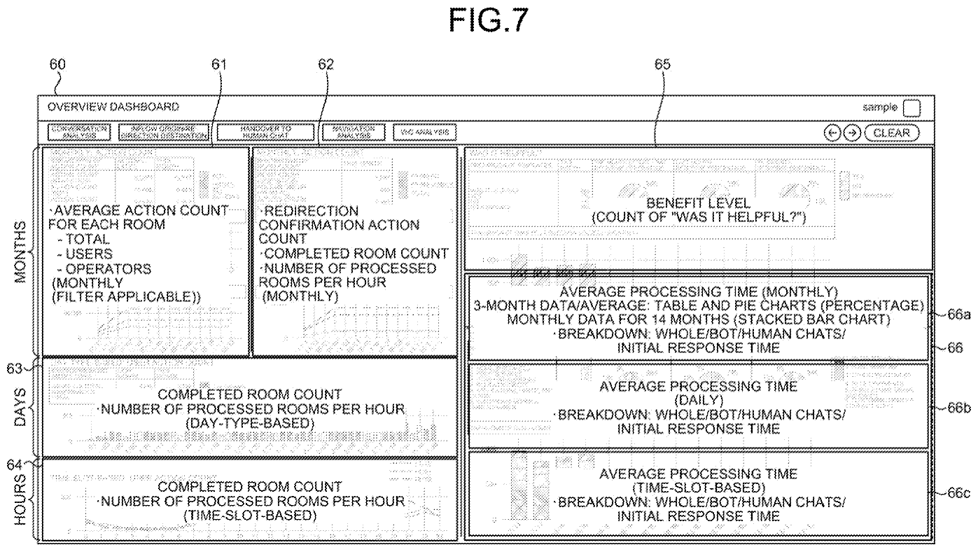

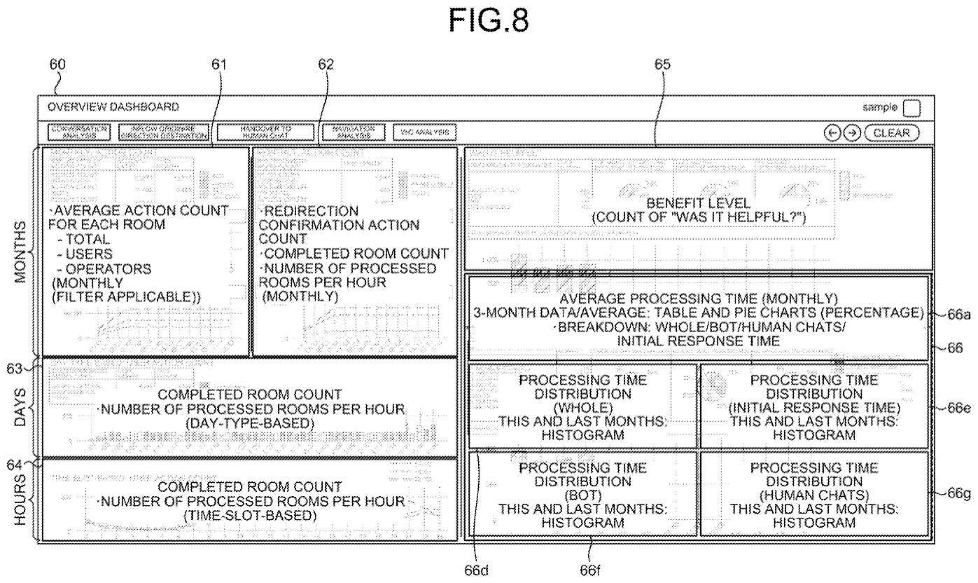

FIGS. 7 and 8 are explanatory drawings illustrating examples of displaying the breakdowns of the analyses on the human services. As illustrated in FIG. 7, when displaying the breakdowns of the analyses on the human services, the dashboard screen 60 displays the content of the analyses narrowing down on such data that involves a relay (a handover) from an automated chat to a human chat.

More specifically, the action count area 61 displays aggregated data regarding an average action count (a total, users [customers' actions 71], operators [operators' actions 71]) for each room.

Further, the room count area 62 displays data aggregated for each month regarding a redirection confirmation action count, a completed room count, and the number of processed rooms per hour. The redirection confirmation action count denotes the number of actions 71 in which the chatbot made a redirection confirmation by asking “Would you like to be transferred to a human chat?”. The completed room count denotes the number of rooms redirected to a human chat. The number of processed rooms per hour is an index value calculated as “Total log-in hours of the operators”/“A total count of completed rooms of the operators”.

Further, the day-type-based user action count area 63 displays data aggregated for each of the day types regarding the completed room count and the number of processed rooms per hour. Also, the time-slot-based action count area 64 displays data aggregated based on the time slots regarding the completed room count and the number of processed rooms per hour. In addition, the benefit level area 65 displays aggregated data regarding the evaluations of the degrees of benefits made by the customers serviced by the human chats.

The interested field area 66 includes an average processing time (monthly) area 66a, an average processing time (day-type-based) area 66b, and an average processing time (time-slot-based) area 66c. The average processing time (monthly) area 66a is an area displaying, for each month, average processing time regarding the whole, the automated chats (the bot), the human chats, and initial response time. In this situation, the initial response time is an index value indicating the time period that elapsed before an operator made an initial utterance after a handover from an automated chat to a human chat. From the customer's point of view, this index value corresponds to a waiting time period before the initial response was given after the transition to the human chat. The average processing time (monthly) area 66a displays aggregated data of average processing time regarding the whole, the automated chats (the bot), the human chats, and the initial response time, based on the processing time from the start to the end of the actions 71 regarding the whole, the automated chats, and the human chats.

The average processing time (day-type-based) area 66b is an area displaying, for each of the day types, average processing time regarding the whole, the automated chats (the bots), the human chats, and the initial response time. Similarly to the average processing time (monthly) area 66a, the average processing time (day-type-based) area 66b displays aggregated data that is aggregated for each of the day types, based on the processing time from the start to the end of the actions 71 regarding the whole, the automated chats, and the human chats.

The average processing time (time-slot-based) area 66c is an area displaying, based on the time slots, average processing time regarding the whole, automated chats (the bot), the human chats, and the initial response time. Similarly to the average processing time (monthly) area 66a, the average processing time (time-slot-based) area 66c displays aggregated data that is aggregated based on the time slots, based on the processing time from the start to the end of the actions 71 regarding the whole, the automated chats, and the human chats. As described herein, the interested field area 66 displays the at-a-glance view of the breakdowns of the aggregation in a chronological order corresponding to monthly, day-type-based, time-slot-based, and the like. With these arrangements, the user is able to easily view chronological changes.

As illustrated in FIG. 8, the interested field area 66 may be configured so as to include a processing time distribution (whole) area 66d, a processing time distribution (initial response time) area 66e, a processing time distribution (bot) area 66f, and a processing time distribution (human chats) area 66g. Similarly to the average processing time (monthly) area 66a, the display in the processing time distribution (whole) area 66d, the processing time distribution (initial response time) area 66e, the processing time distribution (bot) area 66f, and the processing time distribution (human chats) area 66g may be realized by aggregating data based on the processing time from the start to the end of the actions 71 regarding the whole, the automated chats, and the human chats.

The processing time distribution (whole) area 66d is an area displaying a distribution of processing time of the whole in the current month and the last month, for example, by using a histogram or the like. The processing time distribution (initial response time) area 66e is an area displaying a distribution of processing time (initial response time) in the current month and the last month, for example, by using a histogram or the like. The processing time distribution (bot) area 66f is an area displaying a distribution of processing time (bot) in the current month and the last month, for example, by using a histogram or the like. The processing time distribution (human chats) area 66g is an area displaying a distribution of processing time (human chats) in the current month and the last month, for example, by using a histogram or the like.

Further, as observed in the processing time distribution (whole) area 66d and the processing time distribution (human chats) area 66g, the example in FIG. 8 provides the at-a-glance view of the breakdowns in which mutually-corresponding indices are arranged side by side, with respect to the indices of the human services and the indices of the chatbot services. With this arrangement, the user is able to easily compare the indices related to the human services with the indices related to the chatbot services.

Returning to the description of FIG. 4, subsequent to step S67, the display processing unit 55 judges whether or not there has been a designation of a criterion used for narrowing down the data, based on a user instruction received from the analyzing terminal 6 via the input unit 56 (step S68). More specifically, when an operation is performed to select a predetermined index on the dashboard screen 60, the display processing unit 55 determines that there has been a designation that the selected index is to be used as a narrow-down criterion.

When there has been no designation of a narrow-down criterion (step S68: No), the display processing unit 55 proceeds to step S69. On the contrary, when there has been a designation of a narrow-down criterion (step S68: Yes), the display processing unit 55 returns the process to step S65 so as to display narrowed-down aggregated data after bundling the data together according to the narrow-down criterion.

Accordingly, the display processing unit 55 further bundles data together by using the narrow-down criterion, from the analysis results gathered by referring to the data integration DB 50 and thereby generates display data 55a displaying the re-bundled analysis results. The display data 55a is output to the analyzing terminal 6, so that the dashboard screen 60 of the analyzing terminal 6 updates the displayed data with the narrowed-down analysis results.

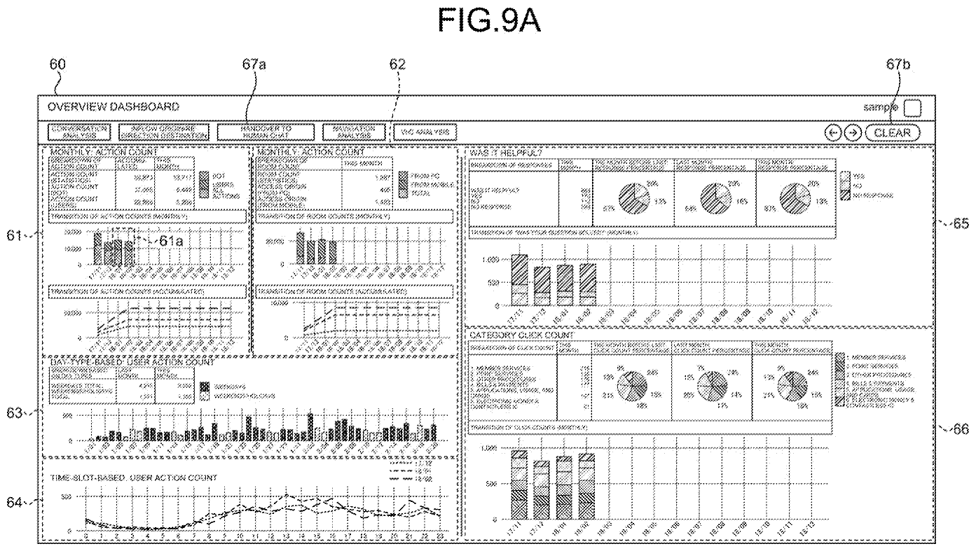

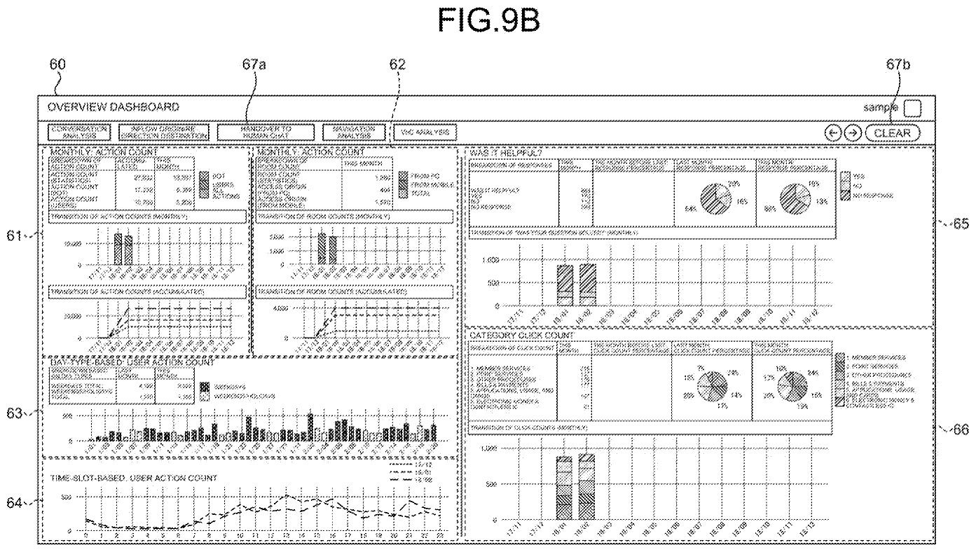

FIGS. 9A and 9B are explanatory drawings for explaining the narrow-down process using a criterion. As illustrated in FIG. 9A, on the dashboard screen 60, a plurality of months (18/01 and 18/02 in the illustrated example) are selected from the indices in the action count area 61, as a narrow-down criterion. Accordingly, the display processing unit 55 bundles together the data corresponding to the selected index (the months of 18/01 and 18/02) and thereby generates display data 55a displaying the re-bundled analysis results.

As a result, as illustrated in FIG. 9B, the data being displayed in the areas on the dashboard screen 60 represents the analysis results re-aggregated with the data corresponding to the selected index (the months of 18/01 and 18/02).

As explained above, the analyzing device 5 includes the input unit 56 and the display processing unit 55. The input unit 56 is configured to receive the input of the user instruction via the analyzing terminal 6 or the like. Upon receipt of the instruction to display the content of the inquiries received and gathered from the plurality of terminals 2, the display processing unit 55 is configured to refer to the data integration DB 50 to display, on the dashboard screen 60, the at-a-glance view of the plurality of analysis results obtained by analyzing the content of the inquiries based on the plurality of indices. The data integration DB 50 is configured to store therein the content of the inquiries analyzed based on plurality of indices including the indices related to the human services and the chatbot offered in response to the inquiries. Upon receipt of the designation for the analysis on the human services through the button 67a, the display processing unit 55 is configured to refer to the data integration DB 50 to display, on the dashboard screen 60, the breakdowns of the indices related to the human services and the chatbot, in addition to the statistical information about the human services in the specific temporal units.

On the dashboard screen 60, by referencing the display of the statistical information about the human services in the specific temporal units and the breakdowns of the indices related to the human services and the chatbot, the user is able to easily perform the analyses while separating the human services from the chatbot services.

Further, the display processing unit 55 is configured to display, on the dashboard screen 60, the at-a-glance view of the breakdowns of the lengths of the service time periods of the chatbot chats and the human chats, as the breakdowns of the indices related to the human services and the chatbot services. With this arrangement, the user is able to view the lengths of the service time periods of the chatbot chats and of the human chats. For example, it is therefore possible to compare the lengths of the service time periods between the chatbot chats and the human chats.

Further, in the benefit level area 65 on the dashboard screen 60, the display processing unit 55 is configured to display the at-a-glance view of the benefit levels indicating the degrees of benefits gathered with respect to the human services and the chatbot services. With this arrangement, the user is able to view the benefit levels of the human services and the chatbot services. It is therefore possible to judge, for example, which is more beneficial between the human services and the chatbot services.

Further, in the interested field area 66 on the dashboard screen 60, the display processing unit 55 is configured to display the at-a-glance view of the breakdowns arranged in the chronological order, regarding the indices related to the human services and the chatbot services. With this arrangement, the user is able to easily view the chronological changes in the indices related to the human services and the chatbot services.

Further, in the interested field area 66 on the dashboard screen 60, the display processing unit 55 is configured to display the at-a-glance view of the distributions of the service time periods of the chatbot chats and the human chats, as the breakdowns of the indices related to the human services and the chatbot services. With this arrangement, the user is able to easily view distribution statuses of the service time periods of the chatbot chats and the human chats.

Further, in the interested field area 66 on the dashboard screen 60, the display processing unit 55 is configured to display the at-a-glance view of the breakdowns in which the mutually-corresponding indices are arranged side by side, with respect to the indices related to the human services and the indices related to the chatbot services. With this arrangement, the user is able to easily compare the indices related to the human services with the indices related to the chatbot services.

The constituent elements of the devices in the drawings do not necessarily have to be physically configured as indicated in the drawings. In other words, specific modes of distribution and integration of the devices are not limited to those illustrated in the drawings. It is acceptable to functionally or physically distribute or integrate all or a part of the devices in any arbitrary units, depending on various loads and the status of use.

Further, all or an arbitrary part of the various types of processing functions implemented by the analyzing device 5 may be executed by a Central Processing Unit (CPU) (or a microcomputer such as a Micro Processing Unit [MPU] or a Micro Controller Unit [MCU]). Further, needless to say, all or an arbitrary part of the various types of processing functions may be executed in a program analyzed and executed by a CPU (or a microcomputer such as an MPU or an MCU) or in hardware using wired logic. Further, the various types of processing functions implemented by the analyzing device 5 may be executed by a collaboration of a plurality of computers using cloud computing.

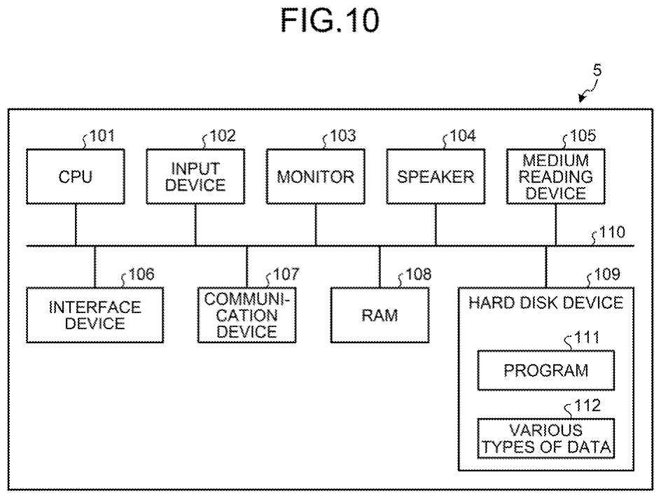

Further, it is possible to realize the various types of processes described in the above embodiments, by causing a computer to execute a program prepared in advance. Thus, the following will describe an example of a computer (hardware) configured to execute the program having the same functions as those in the embodiments described above. FIG. 10 is a block diagram illustrating an exemplary hardware configuration of the analyzing device 5 according to an embodiment.

As illustrated in FIG. 10, the analyzing device 5 includes a CPU 101 configured to perform various types of arithmetic processes; an input device 102 configured to receive data inputs; a monitor 103; and a speaker 104. Further, the analyzing device 5 includes a medium reading device 105 configured to read a program and the like from a storage medium; an interface device 106 for connecting to various types of devices; and a communication device 107 for communicably connecting to an external device in a wired or wireless manner. Further, the analyzing device 5 includes a Random Access Memory (RAM) 108 configured to temporarily store therein various types of information and a hard disk device 109. Further, the functional units (101 to 109) of the analyzing device 5 are connected to a bus 110.

The hard disk device 109 has stored therein a program 111 for executing the various types of processes performed by the bot data analyzing unit 51, the conversation extracting unit 52, the conversation analyzing unit 53, the cleansing unit 54, the display processing unit 55, the input unit 56, the output unit 57, and the like described in the above embodiments. Further, the hard disk device 109 has stored therein various types of data 112 referred to by the program 111. For example, the input device 102 is configured to receive an input of operation information from an operator. For example, the monitor 103 is configured to display various types of screens operated by the operator. For example, a printing device and the like are connected to the interface device 106. The communication device 107 is connected to a communication network such as a Local Area Network (LAN) and is configured to exchange various types of information with an external device via the communication network.

The CPU 101 is configured to perform the various types of processes of the bot data analyzing unit 51, the conversation extracting unit 52, the conversation analyzing unit 53, the cleansing unit 54, the display processing unit 55, the input unit 56, the output unit 57, and the like, by reading the program 111 stored in the hard disk device 109 and executing the program 111 loaded into the RAM 108. In this situation, the program 111 does not necessarily have to be stored in the hard disk device 109. For example, the analyzing device 5 may be configured to read and execute the program 111 stored in a readable storage medium. The storage medium readable by the analyzing device 5 corresponds to, for example, a portable recording medium such as a Compact Disk Read-Only Memory (CD-ROM), a Digital Versatile Disk (DVD), or a Universal Serial Bus (USB) memory; a semiconductor memory such as a flash memory; or a hard disk drive. Further, another arrangement is also acceptable in which the program 111 is stored in a device connected to a public line, the Internet, a LAN, or the like, so that the analyzing device 5 reads and executes the program 111 from such a device.

According to one embodiment of the present invention, it is possible to easily perform an analysis while separating human services from chatbot services.

### BRIEF DESCRIPTION OF DRAWINGS

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing therein an analyzing program that causes a computer to execute a process comprising:
referring to a storage, upon receipt of an instruction to display content of inquiries received and gathered from a plurality of terminals, the storage storing therein the content of the inquiries analyzed based on a plurality of indices including indices related to a human service and a chatbot service offered in response to the inquiries, and displaying an at-a-glance view of a plurality of analysis results obtained by analyzing the content of the inquiries based on the plurality of indices; and
displaying, upon receipt of a designation for an analysis on the human service among the plurality of analysis results displayed in the at-a-glance view, a breakdown of the indices related to the human service and the chatbot service, in addition to statistical information about the human service for each specific unit time period.

2. The analyzing program according to claim 1, wherein the displaying the at-a-glance view includes displaying an at-a-glance view of a breakdown of service time periods of a chatbot chat and a human chat, as the breakdown of the indices related to the human service and the chatbot service.

3. The analyzing program according to claim 1, wherein the displaying the at-a-glance view includes displaying an at-a-glance view of benefit levels indicating degrees of benefit gathered with respect to the human service and the chatbot service.

4. The analyzing program according to claim 1, wherein the displaying the at-a-glance view includes displaying an at-a-glance view of a breakdown in which the indices related to the human service and the chatbot service are arranged in a chronological order.

5. The analyzing program according to claim 1, wherein the displaying the at-a-glance view includes displaying an at-a-glance view of a distribution of service time periods of a chatbot chat and a human chat, as the breakdown of the indices related to the human service and the chatbot service.

6. The analyzing program according to claim 1, wherein the displaying the at-a-glance view includes displaying an at-a-glance view of a breakdown in which mutually-corresponding indices are arranged side by side, with respect to an index related to the human service and an index related to the chatbot service.

7. An analyzing method comprising:
referring to a storage, upon receipt of an instruction to display content of inquiries received and gathered from a plurality of terminals, the storage storing therein the content of the inquiries analyzed based on a plurality of indices including indices related to a human service and a chatbot service offered in response to the inquiries, and displaying an at-a-glance view of a plurality of analysis results obtained by analyzing the content of the inquiries based on the plurality of indices, by a processor; and
displaying, upon receipt of a designation for an analysis on the human service among the plurality of analysis results displayed in the at-a-glance view, a breakdown of the indices related to the human service and the chatbot service, together with statistical information about the human service for each specific unit time period.

8. The analyzing method according to claim 7, wherein the displaying the at-a-glance view includes displaying an at-a-glance view of a breakdown of service time periods of a chatbot chat and a human chat, as the breakdown of the indices related to the human service and the chatbot service.

9. The analyzing method according to claim 7, wherein the displaying the at-a-glance view includes displaying an at-a-glance view of benefit levels indicating degrees of benefit gathered with respect to the human service and the chatbot service.

10. The analyzing method according to claim 7, wherein the displaying the at-a-glance view includes displaying an at-a-glance view of a breakdown in which the indices related to the human service and the chatbot service are arranged in a chronological order.

11. The analyzing method according to claim 7, wherein the displaying the at-a-glance view includes displaying an at-a-glance view of a distribution of service time periods of a chatbot chat and a human chat, as the breakdown of the indices related to the human service and the chatbot service.

12. The analyzing method according to claim 7, wherein the displaying the at-a-glance view includes displaying an at-a-glance view of a breakdown in which mutually-corresponding indices are arranged side by side, with respect to an index related to the human service and an index related to the chatbot service.

13. An analyzing device comprising:
a processor configured to:
receive an input of an instruction from a user, and
refer to a storage, upon receipt of an instruction to display content of inquiries received and gathered from a plurality of terminals, the storage storing therein the content of the inquiries analyzed based on a plurality of indices including indices related to a human service and a chatbot service offered in response to the inquiries; to display an at-a-glance view of a plurality of analysis results obtained by analyzing the content of the inquiries based on the plurality of indices, and display, upon receipt of a designation for an analysis on the human service among the plurality of analysis results displayed in the at-a-glance view, a breakdown of the indices related to the human service and the chatbot service, together with statistical information about the human service for each specific unit time period.

14. The analyzing device according to claim 13, wherein the processor is further configured to display an at-a-glance view of a breakdown of service time periods of a chatbot chat and a human chat, as the breakdown of the indices related to the human service and the chatbot service.

15. The analyzing device according to claim 13, wherein the processor is further configured to display an at-a-glance view of benefit levels indicating degrees of benefit gathered with respect to the human service and the chatbot service.

16. The analyzing device according to claim 13, wherein the processor is further configured to display an at-a-glance view of a breakdown in which the indices related to the human service and the chatbot service are arranged in a chronological order.

17. The analyzing device according to claim 13, wherein the processor is further configured to display an at-a-glance view of a distribution of service time periods of a chatbot chat and a human chat, as the breakdown of the indices related to the human service and the chatbot service.

18. The analyzing device according to claim 13, wherein the processor is further configured to display an at-a-glance view of a breakdown in which mutually-corresponding indices are arranged side by side, with respect to an index related to the human service and an index related to the chatbot service.
